(19) United States
(12) Patent Application Publication
(10) Pub. No.: US 2004/0115985 A1
(43) Pub. Date: Jun. 17, 2004

(54) Electrical connector with strain relief for flat flexible circuitry

(76) Inventors: Yves LePottier, Grosse Pointe, MI (US); Robert M. Fuerst, West Bloomfield, MI (US); David A. Pfaffinger, Holly, MI (US); Jonathan D. Lohman, West Chicago, IL (US)

Correspondence Address: MOLEX INCORPORATED, 2222 WELLINGTON COURT, LISLE, IL, 60532, US

(21) Appl. No.: 09/960,171

(22) Filed: Sep. 21, 2001

(51) Int. Cl. H01R 13/58

(52) U.S. Cl. 439/465

(57) ABSTRACT

A connector is provided for electrically terminating a flat flexible circuit and includes a relatively rigid body member on which the flat flexible circuit is positioned. A relatively yieldable backing structure is attached to the body member beneath the flat flexible circuit. A relatively rigid cover member is securable to the body member over the flat flexible circuit. The cover member includes a pressure surface engageable with the flat flexible circuit to clamp the circuit into engagement with the yieldable backing structure to provide strain relief for the circuit.

### FIELD OF THE INVENTION

This invention generally relates to the art of electrical connectors and, particularly, to connectors for electrically interconnecting flat flexible circuitry.

### BACKGROUND OF THE INVENTION

A flat flexible circuit conventionally includes an elongated flat flexible dielectric substrate having laterally spaced strips of conductors on one or both sides thereof. The conductors may be covered with a thin, flexible protective layer on one or both sides of the circuit. If protective layers are used, openings are formed therein to expose the underlying conductors at desired contact locations where the conductors are to engage the conductors of a complementary mating connecting device which may be a second flat flexible circuit, a printed circuit board or the discrete terminals of a mating connector.

A wide variety of connectors have been designed over the years for terminating or interconnecting flat flexible circuits with complementary mating connecting devices. However, problems continue to be encountered with such connectors. For instance, it often is difficult to adequately secure the flat flexible circuit to the connector and to maintain the circuit taut particularly in the area where the conductors of the circuit engage the conductors of the mating connecting device. The most common securing system employs posts extending through holes in the circuit substrate. Unfortunately, the holes take away from the total usable conductor routing width of the circuit. The present invention is directed to solving these problems with a new and improved securing means or strain relief system for electrical circuitry in such connectors.

### SUMMARY OF THE INVENTION

An object, therefore, of the invention is to provide a new and improved connector for electrically interconnecting the conductors of a flat flexible circuit to the conductors of a complementary mating connecting device.

In the exemplary embodiment of the invention, the connector includes a relatively rigid body member on which the flat flexible circuit is positioned, with the conductors of the circuit facing away from the body member for engaging the conductors of the mating connecting device. A relatively yieldable backing structure is attached to the body member beneath the flat flexible circuit. A relatively rigid cover member is securable to the body member over the flat flexible circuit. The cover member includes a pressure surface engageable with the circuit to clamp the circuit into engagement with the yieldable backing structure to provide strain relief for the circuit.

According to one aspect of the invention, the yieldable backing structure comprises an elongated resilient strip extending transversely of the flat flexible circuit. Preferably, the elongated resilient strip is of a generally uniform thickness along its length, and the strip extends substantially the entire width of the flat flexible circuit.

According to another aspect of the invention, the yieldable backing structure is a first backing structure, and a second relatively yieldable backing structure is attached to the body member beneath the flat flexible circuit. The second backing structure is spaced from the first backing structure and is located for biasing the conductors of the flat flexible circuit against the conductors of the complementary mating connecting device. Complementary interengaging locating means may be provided between the flat flexible circuit and the rigid body member on a side of the second backing structure opposite the side where the first backing structure is located.

As disclosed herein, the yieldable backing structure is of elastomeric material. The yieldable backing structure may be a molded-in-place component, it may be an integral component with the body member, or it may be separate from the body member and fixed thereto.

A further feature of the invention includes the provision of complementary interengaging latch means between the body member and the cover. The latch means holds the cover on the body member, biasing the flat flexible circuit into engagement with the yieldable backing structure.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a front perspective view of a connector embodying the concepts of the invention, in open condition;

FIG. 2 is a rear perspective view of the connector, in open condition;

FIG. 3 is a view similar to that of FIG. 1, with the flat flexible circuit being assembled to the connector;

FIG. 4 is a view similar to that of FIGS. 1 and 3, with the circuit fully assembled to the connector;

FIG. 5 is a view similar to that of FIG. 2, with the circuit fully assembled to the connector;

FIG. 6 is a view similar to that of FIG. 4, with the connector cover in closed condition;

FIG. 7 is a rear perspective view of the connector, with the cover in closed condition;

FIG. 8 is a vertical section taken generally along line 8-8 of FIG. 7; and

FIG. 9 is a vertical section taken generally along line 9-9 of FIG. 7.

### DETAILED DESCRIPTION OF THE PREFERRED EMBODIMENT

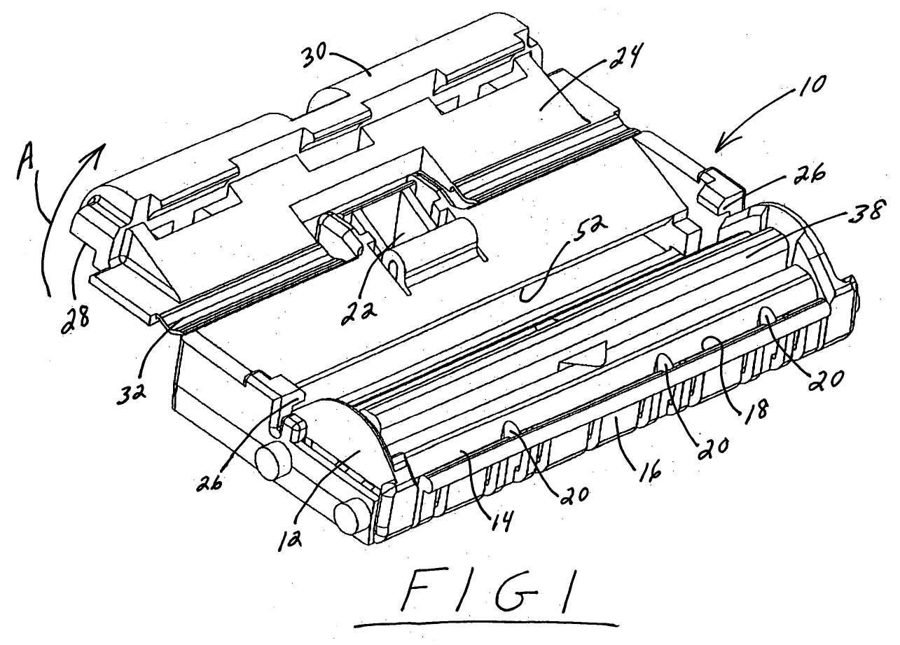

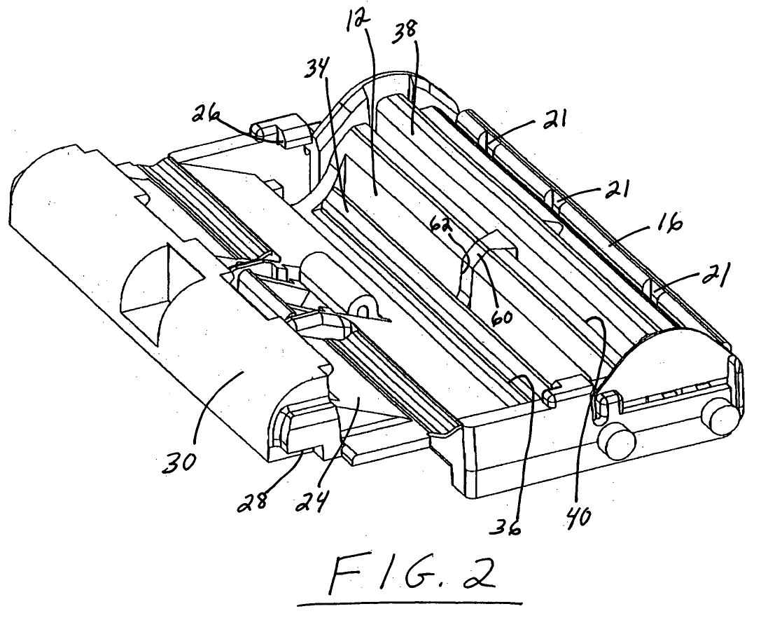

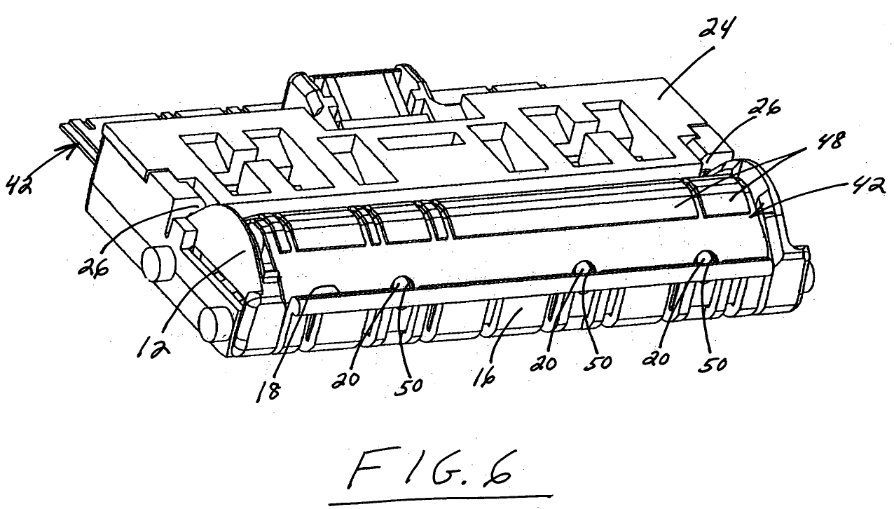

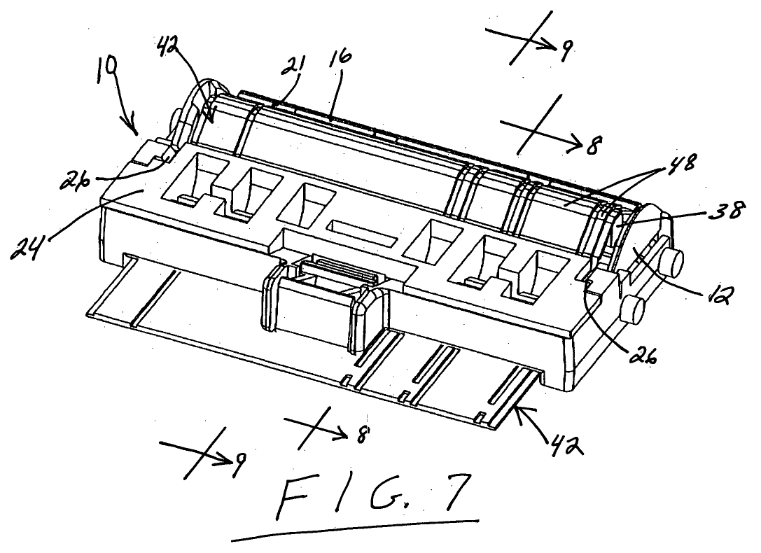

Referring to the drawings in greater detail, and first to FIGS. 1 and 2, the invention is embodied in an electrical connector, generally designated 10, which includes a base in the form of an elongated male body member 12 having a leading edge 14 at which a flat flexible circuit is positioned, as described hereinafter. The entire male body member is unitarily molded of relatively rigid plastic material. An upturned, frontal lip 16 is integrally molded with the body member spaced forwardly of leading edge 14 to define a slot 18 behind the lip in front of the leading edge. A plurality of locating posts 20 project forwardly of the leading edge. Lip 16 has notches 21 (FIG. 2) in the back of the lip aligned with locating posts 20. A latch structure 22 is formed at the rear of the male body member for latching the connector to a complementary mating connecting device, such as a female connector (not shown). A cover 24 is hinged to the body member for pivotal movement in the direction of arrow “A” from an open position shown in FIGS. 1-5 to a closed position shown in FIGS. 6 and 7. A pair of latch arms 26 are formed at opposite sides of the body member for engaging a pair of latch shoulders 28 at opposite sides of the cover to hold the cover in closed position securing the flat flexible circuit within the connector as seen hereinafter.

Cover 24 of connector 10 includes a pressure surface 30 which is engageable with the flat flexible circuit when the cover is in closed condition as described hereinafter. The cover may be integrally joined with the body member by a living hinge 32 of plastic material to facilitate pivoting the cover from its open position to its closed/latched position. On the other hand, a frangible web may be provided at 32 to sever the cover from the body member to move the cover to its closed/latched position. Like the body member, the cover is molded of relatively rigid plastic material and can be molded simultaneously with the body member.

A first relatively yieldable backing structure in the form of an elongated elastomeric strip 34 is attached to male body member 12 within a groove 36 as seen best in FIG. 2. As will be seen hereinafter, when cover member 24 is in its closed position, pressure surface 30 on the cover clamps the flat flexible circuit into engagement with yieldable backing strip 34 to provide strain relief for the circuit.

A second yieldable backing structure in the form of an elongated elastomeric strip 38 is attached to the male body member within a groove 40. Yieldable backing structure 38 is provided for biasing the conductors of the flat flexible circuit against the conductors of the complementary mating connecting device. Both relatively yieldable backing structures or strips 34 and 38 preferably extend substantially the entire width of the flat flexible circuit. Whereas male body member 12 and cover member 24 are molded of relatively rigid plastic material, yieldable backing structures or strips 34 and 38 are fabricated of relatively yieldable material such as silicone rubber or the like.

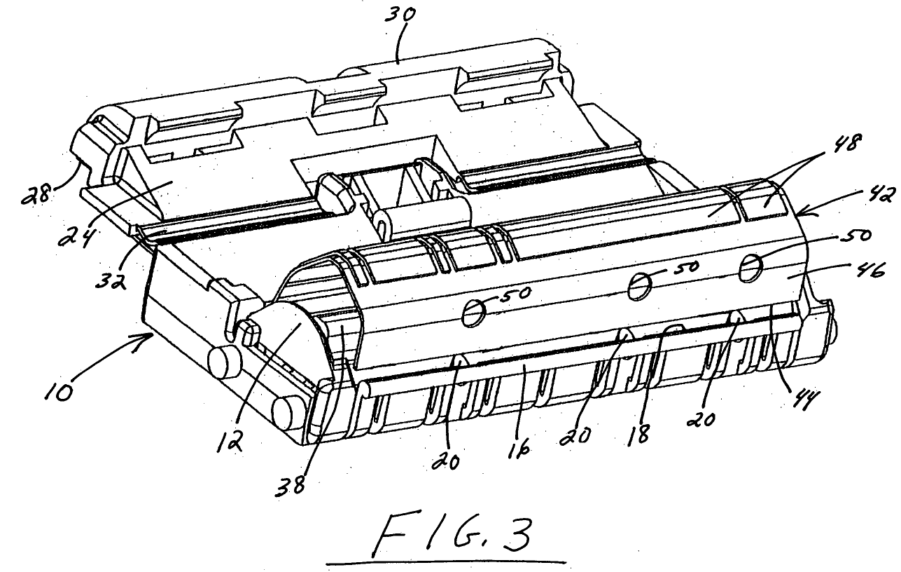

FIG. 3 shows a flat flexible circuit, generally designated 42, in the process of being assembled to connector 10. The circuit is elongated and includes a leading edge 44. The circuit is typical in that it includes an elongated flat flexible dielectric substrate 46 having laterally spaced strips of conductors 48 on one side thereof facing away from male body member 12 for interconnection to the conductors of the complementary mating connecting device. A plurality of locating/latch holes 50 are formed through substrate 46 of flat flexible circuit 42 near edge 44 thereof. The holes engage locating posts 20 at the leading edge of the male body member. It can be seen that yieldable backing structure 38 is beneath the flat flexible circuit immediately behind conductors 48 and maintains the conductors in a raised or convex position for engaging the conductors of the complementary mating connecting device.

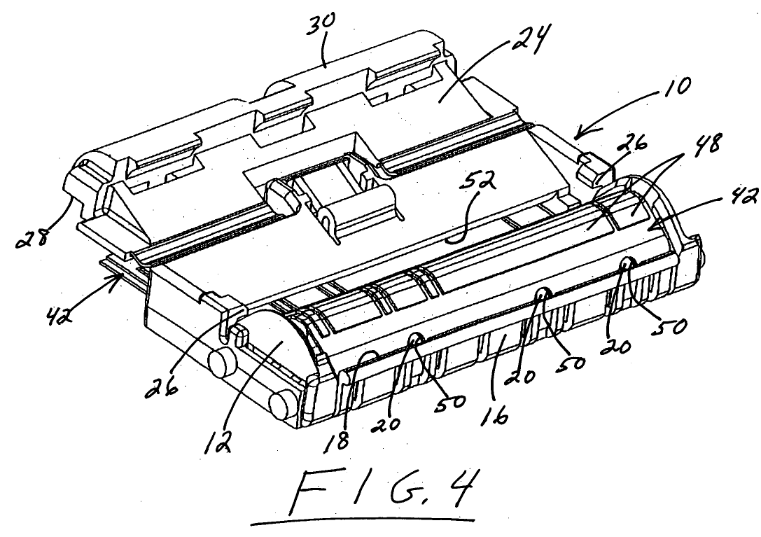

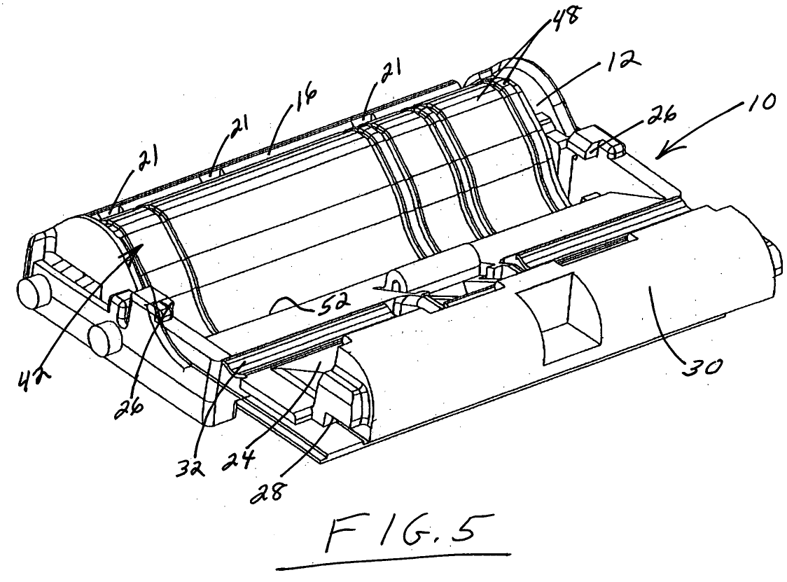

FIGS. 4 and 5 show flat flexible circuit 42 fully assembled to male body member 12, with cover member 24 still in its open position. Locating/latch holes 50 at the leading edge of the circuit are interengaged with locating posts 20 of the male body member. The circuit extends rearwardly through a passage 52 in the male body member.

Although not visible in FIGS. 4 and 5, flat flexible circuit 42 overlies both yieldable backing strips 34 and 38 (FIG. 2) across substantially the entire width of the circuit.

FIGS. 6 and 7 show cover member 24 pivoted and closed down onto male body member 12 and held in closed position by latch arms 26. Flat flexible circuit 42 now is held rigidly in the connector, with conductors 48 facing away therefrom for interconnection to the conductors of the complementary mating connecting device.

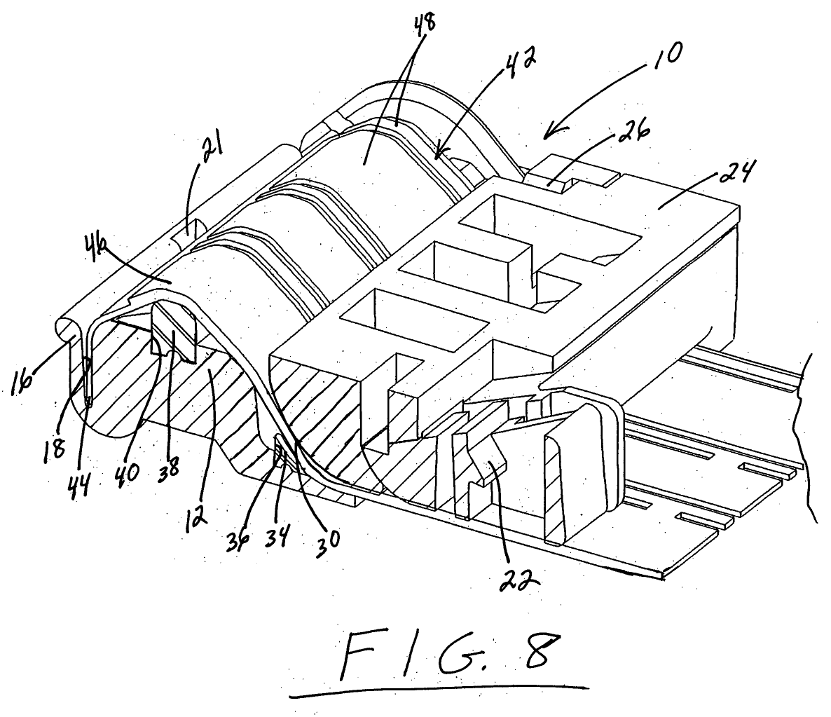

FIG. 8 best shows how cover member 24 cooperates with relatively yieldable backing structure or strip 34 to provide strain relief for flat flexible circuit 42. In particular, it can be seen in FIG. 8 that cover 24 is in its closed/latched position. Pressure surface 30 of the cover member can be seen to be engaged with the top of substrate 46 of the circuit, biasing the circuit into engagement with yieldable backing strip 34. It also can be seen in FIG. 8 that leading edge 44 of the circuit is disposed in slot 18 behind lip 16, whereat the locating/latch holes 50 (FIG. 3) are in engagement with locating posts 20. With this interengagement, and with the circuit being bent over the top of second yieldable backing structure or strip 38, the clamping of the circuit against yieldable backing structure 34 by cover 24 is effective to maintain the circuit taut between locating posts 20 and yieldable backing structure 34 over the top of yieldable backing structure 38.

The invention contemplates various methods of attaching yieldable backing structures 34 and 38 to male body member 12 as seen in FIG. 8. One method is to mold or otherwise fabricate the two yieldable backing structures as separate molded components secured in place within grooves 36 and 40. The backing structures may be maintained within the grooves by a press fit or with the use of fixing adhesives. On the other hand, yieldable backing structures 34 and/or 38 can easily be molded-in-place within grooves 36 and 40. The invention contemplates that the molded-in-place backing structures can be insert molded within the grooves after the body member is first molded, using the body member as part of the molding die. On the other hand, it is contemplated that the backing structures can be molded in a “two-shot” fabricating process. In the “two-shot” process, the relatively rigid plastic material of male body member 12 is injected into the die in one shot, the silicone rubber of backing structure 34 and 38 is injected in a second shot, and the materials are cured either simultaneously or sequentially, i.e., the plastic material is cured during the second shot injection.

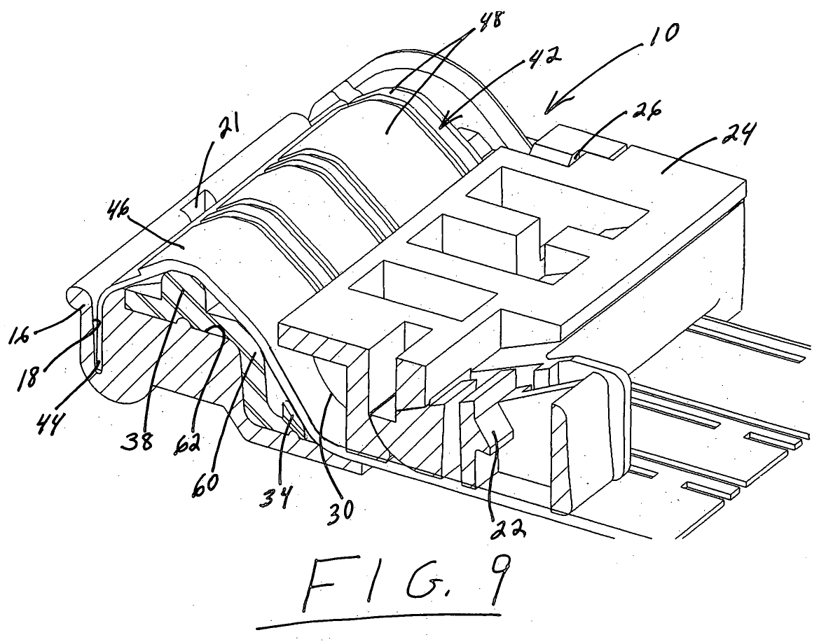

With either the insert molded process or the “two-shot” process, backing structures 34 and 38 effectively become integral with the molded male body member. The backing structures can be joined by an integral web 60 as seen in FIG. 9. This integral web also can be seen in FIG. 2. The web is molded within a cross groove 62 (FIG. 2). In essence, groove 60 in the male body member communicates between elongated grooves 36 and 40 (FIGS. 2 and 8) to allow the silicone rubber material to flow throughout all of the grooves with uniformity during either the inserted molded process or the “two-shot” process.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A connector for electrically interconnecting conductors of a flat flexible circuit to conductors of a complementary mating connecting device, comprising:
a relatively rigid body member on which the flat flexible circuit is positioned with the conductors of the circuit facing away from the body member for engaging the conductors of the complementary mating connecting device;
a relatively yieldable backing structure attached to the body member beneath the flat flexible circuit; and
a relatively rigid cover member securable to the body member over the flat flexible circuit, the cover member including a pressure surface engageable with the flat flexible circuit to clamp the circuit into engagement with the yieldable backing structure to provide strain relief for the circuit.

2. The connector of claim 1 wherein said yieldable backing structure comprises an elongated resilient strip extending transversely of the flat flexible circuit.

3. The connector of claim 2 wherein said elongated resilient strip is of a generally uniform thickness along the length thereof.

4. The connector of claim 3 wherein said elongated resilient strip extends substantially the entire width of the flat flexible circuit.

5. The connector of claim 1 wherein said yieldable backing structure is of elastomeric material.

6. The connector of claim 1 wherein said yieldable backing structure is a molded-in-place component.

7. The connector of claim 1 wherein said yieldable backing structure is separate from the body member and fixed thereto.

8. The connector of claim 1 wherein said yieldable backing structure is integral with the body member.

9. The connector of claim 1 wherein said relatively yieldable backing structure comprises a first backing structure, and including a second relatively yieldable backing structure attached to the body member beneath the flat flexible circuit, the second backing structure being spaced from the first backing structure and located for biasing the conductors of the flat flexible circuit against the conductors of the complementary mating connecting device.

10. The connector of claim 9 wherein said second yieldable backing structure comprises an elongated resilient strip extending transversely of the flat flexible circuit.

11. The connector of claim 10 wherein said elongated resilient strip is of a generally uniform thickness along the length thereof and extends substantially the entire width of the flat flexible circuit.

12. The connector of claim 1, including complementary interengaging latch means between the body member and the cover member to hold the cover member on the body member biasing the flat flexible circuit into engagement with the yieldable backing structure.

13. A connector for electrically interconnecting conductors of a flat flexible circuit to conductors of a complementary mating connecting device, comprising:
a relatively rigid body member on which the flat flexible circuit is positioned with the conductors of the circuit facing away from the body member for engaging the conductors of the complementary mating connecting device;
a first relatively yieldable backing structure of elastomeric material attached to the body member beneath the flat flexible circuit, the first yieldable backing structure comprising an elongated strip of generally uniform thickness along the length thereof and extending transversely of the flat flexible circuit substantially the entire width of the circuit;
a relatively rigid cover member securable to the body member over the flat flexible circuit, the cover member including a pressure surface engageable with the flat flexible circuit to clamp the circuit into engagement with the first yieldable backing structure to provide strain relief for the circuit; and
a second relatively yieldable backing structure of elastomeric material attached to the body member beneath the flat flexible circuit, the second backing structure being spaced from the first backing structure and located for biasing the conductors of the flat flexible circuit against the conductors of the complementary mating connecting device.

14. The connector of claim 13 wherein said second yieldable backing structure is of a generally uniform thickness along the length thereof and extends substantially the entire width of the flat flexible circuit.

15. The connector of claim 13 wherein both said first and second yieldable backing structures are molded-in-place components.

16. The connector of claim 13 wherein both said first and second yieldable backing structures are separate from the body member and fixed thereto.

17. The connector of claim 13 wherein both said first and second yieldable backing structures are integral with the body member.

18. The connector of claim 13, including complementary interengaging latch means between the body member and the cover member to hold the cover member on the body member biasing the flat flexible circuit into engagement with the first yieldable backing structure.

19. The connector of claim 13, including complementary interengaging securing means between the body member and the flat flexible circuit on a side of the second relatively yieldable backing structure opposite a side of the second yieldable backing structure from which the first yieldable backing structure is spaced.

20. The connector of claim 19 wherein said securing means comprises at least one post on the body member for insertion into a hole in the flat flexible circuit.

21. A connector for terminating a flat flexible circuit, comprising:
a relatively rigid body member on which the flat flexible circuit is positioned;
a relatively yieldable backing structure attached to the body member beneath the flat flexible circuit; and
a relatively rigid cover member securable to the body member over the flat flexible circuit, the cover member including a pressure surface engageable with the flat flexible circuit to clamp the circuit into engagement with the yieldable backing structure to provide strain relief for the circuit.

22. The connector of claim 21 wherein said yieldable backing structure comprises an elongated resilient strip extending transversely of the flat flexible circuit.

23. The connector of claim 22 wherein said elongated resilient strip is of a generally uniform thickness along the length thereof.

24. The connector of claim 23 wherein said elongated resilient strip extends substantially the entire width of the flat flexible circuit.

25. The connector of claim 21 wherein said yieldable backing structure is of elastomeric material.

26. The connector of claim 21 wherein said yieldable backing structure is a molded-in-place component.

27. The connector of claim 21 wherein said yieldable backing structure is separate from the body member and fixed thereto.

28. The connector of claim 21 wherein said yieldable backing structure is integral with the body member.

29. The connector of claim 21, including complementary interengaging latch means between the body member and the cover member to hold the cover member on the body member biasing the flat flexible circuit into engagement with the yieldable backing structure.
